(19) United States
(12) Patent Application Publication
(10) Pub. No.: US 2020/0118121 A1
(43) Pub. Date: Apr. 16, 2020

(54) METHOD AND SYSTEM FOR PROCESSING PAYMENT TRANSACTIONS WITH ENCRYPTED IMAGES

(71) Applicant: Mastercard International Incorporated, Purchase, NY (US)

(72) Inventors: Bhupinder Singh Narang, Gurgaon (IN); Ashish Jain, Gurgaon (IN); Pulkit Gupta, New Delhi (IN)

(73) Assignee: Mastercard International Incorporated, Purchase, NY (US)

(21) Appl. No.: 16/555,553

(22) Filed: Aug. 29, 2019

(30) Foreign Application Priority Data
Oct. 12, 2018 (SG) 10201809006U

(51) Int. Cl. G06Q 20/38; G06Q 20/40; G06T 1/00

(52) U.S. Cl. CPC G06Q 20/385; G06T 1/0021; G06Q 20/3821; G06Q 20/4014

(57) ABSTRACT

A method and server system for facilitating processing of payment transactions with encrypted images are disclosed. The server system receives an encrypted image from a device of a user. The encrypted image includes a device identifier (ID) associated with the device, and at least one payment transaction information associated with a payment account of the user. The device ID and the at least one payment transaction information are extracted from the encrypted image. The extracted device ID is matched with an available device ID at the server system. Subsequent to successful matching of the device ID with the available device ID, a payment transaction is processed using the payment account based on the at least one payment transaction information.

### CROSS REFERENCE TO RELATED APPLICATIONS

This application claims priority to Singaporean Application Serial No. 10201809006U, filed Oct. 12, 2018, which is incorporated herein by reference in its entirety

### TECHNICAL FIELD

The present disclosure generally relates to payments from customers to merchants for goods or services purchased from the merchants and, more particularly to, a method and system for processing payment transactions with encrypted images.

### BACKGROUND

Nowadays, a large volume of payment transactions is executed online through websites or portals capable of facilitating payments from customers to merchants. Typically, a customer enters details of a payment card (for example, a credit card, a debit card or any such banking card) on the payment website/portal to initiate a payment transaction. The details of the payment card may be routed to an issuer of the payment card for authorization of the payment transaction. The issuer may also authenticate an identity of the cardholder (i.e. the customer), for example by using one-time password (OTP) or any such means. Subsequent to successful authentication of the cardholder identity, the issuer may approve the payment transaction and initiate the transfer of funds from a payment account associated with the cardholder to a merchant payment account.

Most payment websites/portals aim to provide the users with a better consumer experience of executing payment transactions, which is also easy and secure. However, current solutions for providing a seamless experience of executing payment transactions, have several drawbacks. For example, most payment websites/portals require a user to provide an input corresponding to the details of the payment card on an UI associated with the respective payment website/portal. On devices with small form factor, such as a mobile phone for example, providing input related to the details of the payment card may be cumbersome on account of the small screen size. Further, if the user makes a mistake in the input, on account of having to provide an entry including several digits, the entire process may have to be repeated, which is cumbersome for the user. Furthermore, if the user executes the payment transaction in a public space, there is a risk of information leakage as someone near to the user can see/trace what the user is typing.

In scenarios where the card is not present with the user, currently, the user may have to remember the details of the payment card to execute the payment transaction, which may be difficult for the user. Storing card information in the device to avoid providing key entries may also be a risk as the stored data is vulnerable to threats related to data theft.

Moreover, the authentication of the cardholder identity is generally executed using two factor authentication means, such as for example, by sending an OTP to the user's registered device. The current OTP based authentication mechanism has recently been a target for several vishing frauds. Further, customers dwelling at locations with poor network coverage may not receive the OTP in time. In some scenarios, the customers traveling to foreign locations may not carry their Subscriber Identity Module (SIM) card and therefore, such customers may not be able authenticate OTP SMS dependent payment transactions.

Accordingly, there is a need to overcome the above-mentioned drawbacks and process payment transactions while providing a seamless experience, which is both secure and easy, to the users.

### SUMMARY

Various embodiments of the present disclosure provide methods and systems for processing payment transactions with encrypted images.

In an embodiment, a payment processing method is disclosed. The method includes receiving, by a server system associated with a payment network, an encrypted image from a device of a user. The encrypted image includes a device identifier (ID) associated with the device, and at least one payment transaction information associated with a payment account of the user. The method includes extracting, by the server system, the device ID and the at least one payment transaction information from the encrypted image. The method includes matching, by the server system, the device ID with an available device ID at the server system. The method includes processing, by the server system, a payment transaction using the payment account based on the at least one payment transaction information, subsequent to successful matching of the device ID with the available device ID.

In another embodiment, a server system in a payment network for processing payments is disclosed. The server system includes a memory including stored instructions and at least one processor communicably coupled to the memory. The processor is configured to execute the stored instructions to cause the server system to receive an encrypted image from a device of a user. The encrypted image includes a payment card information associated with a payment card of the user. The server system is caused to extract a device ID of the device of the user from a communication associated with the encrypted image between the device and the server system. The server system is caused to match the device ID with an available device ID with the server system. Subsequent to successful matching of the device ID with the available device ID, the server system is further caused to extract the payment card information from the encrypted image. The server system is further caused to process a payment transaction using the payment card based on the payment card information extracted from the encrypted image.

In an embodiment, an issuer server in a payment network for processing payments is disclosed. The issuer server includes a memory including stored instructions and at least one processor communicably coupled to the memory. The processor is configured to execute the stored instructions to cause the issuer server to receive an encrypted image from a device of a user. The encrypted image includes a device identifier (ID) associated with the device, and a one-time password (OTP) for processing a payment transaction using a payment card of the user. The issuer server is caused to extract the device ID and the OTP from the encrypted image. The issuer server is caused to match the device ID with an available device ID. Subsequent to successful matching of the device ID with the available device ID, the issuer server is caused to process the payment transaction using the payment card.

### BRIEF DESCRIPTION OF THE FIGURES

For a more complete understanding of example embodiments of the present technology, reference is now made to the following descriptions taken in connection with the accompanying drawings in which:

FIG. 1 shows a representation for illustrating an example online payment transaction, in accordance with an example embodiment of the present disclosure;

FIG. 2A shows a representation of a sequence flow for illustrating a generation of an encrypted image for use in processing payment transactions, in accordance with an example embodiment of the present disclosure;

FIG. 2B shows a representation of a sequence flow for illustrating a generation of an encrypted image for use in processing payment transactions, in accordance with another example embodiment of the present disclosure;

FIG. 3 shows an example UI for illustrating a provisioning of an encrypted image generation request by a user, in accordance with an example embodiment of the present disclosure;

FIG. 4 shows a representation for illustrating a generation of an encrypted image, in accordance with an example embodiment of the present disclosure;

FIG. 5 shows a representation of a UI associated with a merchant check out page for illustrating the use of encrypted images in processing payment transactions, in accordance with an example embodiment of the present disclosure;

FIG. 6A shows a representation of a sequence flow for illustrating a processing of a payment transaction with an encrypted image, in accordance with an example embodiment of the present disclosure;

FIG. 6B shows a representation of a sequence flow for illustrating a processing of a payment transaction with an encrypted image, in accordance with another example embodiment of the present disclosure;

FIG. 7 shows a representation of a sequence flow for illustrating a linking of one or more device IDs with a user's payment account, in accordance with an example embodiment of the present disclosure;

FIG. 8 shows a representation of a sequence flow for illustrating a processing of a payment transaction with an encrypted image, in accordance with an example embodiment of the present disclosure;

FIG. 9 illustrates a flow diagram of a method for illustrating a processing of a payment transaction with an encrypted image, in accordance with an example embodiment of the present disclosure;

FIG. 10 illustrates a flow diagram of a method for illustrating a processing of payment transaction with an encrypted image, in accordance with another example embodiment of the present disclosure;

FIG. 11 is a simplified block diagram of a server system configured to facilitate processing of payment transactions with encrypted images, in accordance with an example embodiment of the present disclosure;

FIG. 12 is a simplified block diagram of an issuer server configured to facilitate processing of payment transactions with encrypted images, in accordance with an example embodiment of the present disclosure;

FIG. 13 is a simplified block diagram of an acquirer server configured to facilitate processing of payment transactions with encrypted images, in accordance with an example embodiment of the present disclosure;

FIG. 14 is a simplified block diagram of a payment server configured to facilitate processing of payment transactions with encrypted images, in accordance with an example embodiment of the present disclosure; and

FIG. 15 shows a simplified block diagram of an electronic device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” refers to a financial account that is used to fund the financial transaction (interchangeably referred to as “payment transaction”). Examples of the payment account include, but are not limited to a savings account, a credit account, a checking account and a virtual payment account. The payment account may be associated with an entity such as an individual person, a family, a commercial entity such as a merchant, a company, a corporation, a governmental entity, a non-profit organization, and the like. In some scenarios, a payment account may be a virtual or temporary payment account that can be mapped or linked to a primary payment account, such as those accounts managed by PayPal®, and the like.

The term “payment network”, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

The term “payment card”, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data stored in a user device, where the data is associated with payment account such that the data can be used to process the financial transaction between the payment account and a merchant's financial account.

Overview

Various example embodiments of the present disclosure provide a method and a system for processing payment transactions with encrypted images.

In one embodiment, a server system facilitates processing of payment transactions between users and merchants. The server system may correspond to a server associated with any entity on a payment network. For example, the server system may correspond to a payment server, a server associated with a payment gateway, an acquirer server, an issuer server, a third-party server or a combination of one or more such servers.

In one embodiment, the server system provides an interface to the users. In an illustrative example, the server system provides an application capable of being downloaded by the users onto their respective devices. In such a scenario, the interface provided by the server system corresponds to a user interface (UI) associated with the application displayed on the user's device subsequent to the user access of the application. The application downloaded on the device may be a thin client or an instance of the application stored in the server system. More specifically, the application downloaded on the device may be in operative communication with the server system. In one embodiment, the interface provided by the server system corresponds to a Web page or a UI of an online portal associated with the server system.

A user may access the interface and provide a request for generating an encrypted image. The encrypted image generation request may include an image available in the device of the user and at least one payment transaction information associated with a payment account of the user. The user may use the image which can be captured by a user or an image already available in the user's device or an image obtained from external sources. In one example, the payment transaction information may include a bank account related information or a payment card information associated with the payment account of the user. More specifically, the user may provide either a bank account information, such as a user bank account number, a bank ID, a bank location, etc., or a payment card information, such as information related to a credit card, a debit card or any other banking card linked to the payment account of the user.

In an example, in response to the encrypted image generation request, the server system is configured to capture the device ID of the device from which the request is received and encrypt the payment transaction information (i.e. the payment card information or the bank account information) and the device ID in the image to generate the encrypted image. Without loss of generality, the server system may capture the device ID from the encrypted image generation request as per a protocol used for such communication for example an IP protocol or any wireless protocol, which normally has the details (e.g., device ID) of a sending entity of the encrypted image generation request. In one embodiment, the server system is configured to tokenize the payment transaction information and encrypt the device ID and the payment transaction information using at least one steganographic encryption process. In an embodiment, the at least one steganographic encryption process is configured to use binary representation of colors of pixels associated with the image to conceal the device ID and the at least one payment transaction information for generating the encrypted image. For example, the steganographic encryption process may involve extraction of binary representations of colors configuring the pixels, which are located at predetermined locations. The least significant bits (LSBs) of the binary representations may be manipulated (for example, the LSBs may be flipped) in a predetermined way to conceal the device ID and the payment transaction information in the image to generate the encrypted image using steganography. Subsequent to the generation of the encrypted image, the server system provides the encrypted image to the device. The device may be configured to store the encrypted image in an internal storage associated with the device. In an embodiment, the device ID and the payment transaction information are encrypted in image in a layered encryption format. For instance, the device ID may be encrypted in a region of the image defined as ‘first layered area’ and the payment transaction information may be encrypted in a region of the image defined as ‘second layered area’. Without loss of generality, an example of the first layered area can be a first pre-defined number of pixels in centre of the image and an example of the second layered area can be a second pre-defined number of pixels in each of the corners of the image.

In an alternate embodiment, the device ID may not be a part of the encrypted image, and the device ID is stored separately with the server system. In this embodiment, the server system associates the device ID with the encrypted image. For instance, when the user provides the encrypted image generation request, the server system encrypts the payment transaction information within the image, and tags the captured device ID with the encrypted image. Such tagging is used for authentication during an actual payment transaction.

In an example scenario, the user may initiate a payment to a merchant on a merchant portal. For example, the user may wish to purchase a product being displayed on the merchant portal, and, accordingly, the user may add the product to a purchase cart and proceed to the checkout page on the merchant portal. It is noted that the checkout page on the merchant portal may be associated with a payment network capable of facilitating processing of payment transactions. In at least one example embodiment, the checkout page may be configured to provide an option to pay using an encrypted image. The user may select the option to pay using the encrypted image and upload the encrypted image on the checkout page.

In at least one example embodiment, the server system may be configured to receive the encrypted image uploaded by the user on the merchant portal. As explained above, in some examples, the encrypted image includes the device ID and at least one payment transaction information associated with a payment account of the user. Once the server system receives the encrypted image, the server system performs a first layer of decryption, in which, the server system is configured to extract the device ID from the encrypted image. Further, the server system may be configured to match the device ID available with the server system, with the device ID extracted from the encrypted image. Only if the extracted device ID matches with the available device ID, the server system performs a second layer of decryption. In the second layer of decryption, the server system decrypts (or extracts) the payment transaction information from the encrypted image. Thereafter, the server system is configured to process the payment transaction using the payment account based on the payment transaction information, i.e., based on the bank account information or the payment card information extracted from the encrypted image.

In some examples, where the encrypted image only includes the at least one payment transaction information and not the device ID, the server system is configured to extract the device ID from the script of the payment page and/or from any request/message/communication as per the protocol used for such communication. The server system matches the device ID available with the server system with the device ID extracted from the script, and only upon successful match, the server system is configured to decrypt the at least one payment transaction information from the encrypted image. Thereafter, the server system is configured to process the payment transaction using the payment account based on the payment transaction information.

In one embodiment, the server system may correspond to a server associated with the payment gateway. The server may capture the device ID used by the user for initiating the payment transaction by capturing the device ID from a script of the payment page and/or by capturing device ID as per protocol of a communication between the user device and the payment gateway/server system. The server may also be aware of the image decryption logic (i.e. the logic for decoding the steganographically encrypted image). The server may use the decryption logic to extract the device ID and the payment transaction information from the encrypted image and compare the extracted device ID with the device ID of the user device. Subsequent to the successful matching of the device ID, the server associated with the payment gateway may be configured to provide the payment transaction information to the appropriate issuing bank (i.e. the issuer or the bank associated with the issuance of the payment card or the bank account of the user). A server associated with the issuer, also known as the issuer server, may be configured to authenticate the payment transaction information and upon successful match of the payment transaction information with the stored values of the payment transaction information, initiate a transfer of funds from the user's payment account to the merchant payment account.

The processing of payment transactions using encrypted images precludes the need to input the payment account information on the merchant portal as a user may only need to upload the encrypted image instead. The user also does not need to remember the details of the payment card in a ‘card not present’ scenario as the encrypted image includes all the details of the user's payment card. Further, storing the encrypted image in the device precludes the need to store payment account information in the device, thereby mitigating the threats related to data theft. Furthermore, the user may initiate the payment transaction in a public space and upload the encrypted image on the merchant portal without the risk of leaking payment account information to someone near to the user who can see what the user is typing/tracing.

In some example scenarios, a user may register one or more devices with a server system (for example, an issuer server associated with an issuer of a payment account) for linking the one or more devices to a user payment account to facilitate processing of payments to merchants. The registration process may involve providing device identifiers (IDs) of the one or more devices to the server system, which may link the information to the user's payment account information, such as for example, the user's bank account information or the user's payment card information. Subsequently, when the user initiates a payment to a merchant on a merchant portal and provides, for example, a payment card information, then server system is first configured to match the payment card information entered by the user on the merchant portal with available payment card information. If the payment card information matches, then the server system may be configured to generate a one-time password (OTP) and encrypt the OTP with a linked device ID in an image using steganographic encryption process to generate an encrypted image. The server system may further be configured to provide the encrypted image to the user on the device associated with the device ID encrypted in the image. The user, subsequent to receiving the encrypted image, may upload the encrypted image on the merchant portal to authenticate a personal identity. The server system may be configured to extract the device ID from the device of the user. Further, the server system may be configured to extract the device ID from the encrypted image and match the device ID with the device ID of the device used for uploading the encrypted image on the portal. On successful match, the OTP may be matched with generated OTP at the server system. Subsequent to the successful match, the user identity may be authenticated and the server system may initiate (or cause initiation of) a transfer of funds from the user's payment account to the merchant payment account. The matching of the OTP and the device ID provides two levels of authentication for processing of payments from users to the merchants.

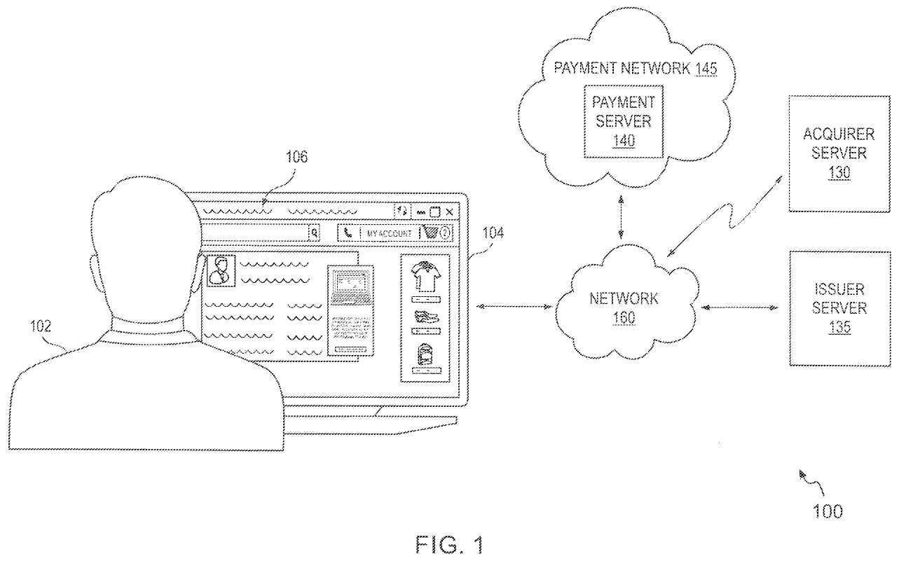

The processing of payments to the merchant using encrypted images is further explained in detail hereinafter with reference to FIGS. 1 to 15.

FIG. 1 shows a representation 100 for illustrating an online payment transaction, in accordance with an example embodiment of the present disclosure. The representation 100 depicts a user 102 to have used a device 104 to visit a merchant website using a Web browser application 106 installed on the device 104. A merchant associated with merchant website may be any entity offering products, services and/or information of user interest for sale. In an illustrative example, the merchant may correspond to a retail enterprise. In another illustrative example, the merchant may correspond to an air travel related enterprise. In yet another illustrative example, the merchant may correspond to a news portal. It is noted that the term ‘merchant’ as used herein may not be limited to public and/or private enterprises but may also include individuals and/or group of individuals offering items for sale.

The user 102 may use the Web browser application 106 to connect to a communication network, such as a network 160, to access the merchant Website. It is noted that the device 104 is depicted to be a desktop computer for illustration purposes and that the device 104 may be an electronic device capable of connecting to a communication network and exchanging communication with remote entities, such as a Web server (not shown in FIG. 1) hosting the merchant portal. The merchant website is also interchangeably referred to hereinafter as a merchant portal.

In an example scenario, the user 102 may select one or more items of interest and proceed to a checkout Web page on the merchant portal. The user 102 may provide details of a payment account, such as for example a payment card information or a bank account information, on the checkout page to initiate a payment to the merchant for purchasing the selected items of interest. Some non-exhaustive examples of payment card details entered using the device 104 include payment card number, date of expiry, Card Verification Value (CVV) details, and the like.

In a non-limiting example, authorization of the user's bank account with sufficient funds for making a transaction of ‘X’ amount to complete the payment transaction is performed by a combination of an acquirer server 130, an issuer server 135 and a payment server 140. In one embodiment, the payment server 140 is associated with a payment network 145. The payment network 145 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

The issuer server 135 is associated with a financial institution normally called as an “issuer bank” or “issuing bank” or simply “issuer”, in which the user 102 may have an account, which issues a payment card, such as a credit card or a debit card. The user 102, being the cardholder, can use the payment card details associated with the payment card to tender payment for a purchase from the merchant.

To accept payment, the merchant must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank.

Using the payment network 145, the computers of the acquirer/the acquirer server 130 or the merchant processor will communicate with the computers of the issuer/the issuer server 135 to determine whether the user's account is in good standing and whether the purchase is covered by the user's available account balance. Based on these determinations, authorization of the payment transaction is declined or accepted. When the authorization is accepted, the available balance of the user's account is decreased. Normally, a charge is not posted immediately to the customer's account because bankcard associations, such as Mastercard International Incorporated®, have promulgated rules that do not allow a merchant to charge, or “capture,” a transaction until goods are shipped or services are delivered. When the merchant ships or delivers the goods or services, the merchant captures the transaction by, for example, appropriate data entry procedures. If the user 102 cancels a transaction before it is captured, a “void” is generated. If the user 102 returns goods after the transaction has been captured, a “credit” is generated.

After a transaction is captured, the transaction is settled between the merchant, the acquirer and the issuer. Settlement refers to the transfer of financial data or funds between the merchant's account, the acquirer, and the issuer, related to the transaction. Usually, transactions are captured and accumulated into a “batch”, which is settled as a group.

A user device (e.g., device 104 of the user 102), the Web server hosting the merchant Website, the issuer server 135, the acquirer server 130 and the payment server 140 communicate with one another using the network 160. Examples of the network 160 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 160 may be or include the Internet, intranets, extranets, microwave networks, satellite communications, cellular systems, personal communication services (“PCS”), infrared communications, global area networks, or other suitable networks, etc., or any combination of two or more such networks.

In at least one example embodiment, the merchant checkout page may provide an option to provide the payment account information using an image. The user may select the option to provide the payment account information using an image and upload an encrypted image on the merchant portal, i.e. on the checkout page of the merchant portal. The payment transaction may then be processed by a combination of the acquirer server 130, the payment server 140 and the issuer server 135. The processing of payment transactions using encrypted images precludes the need to input the payment account information on the merchant site as a user may upload the encrypted image instead. As the encrypted image includes all the details of the user's payment account, the user also does not need to remember/memorize the details of the payment account, which may be especially be beneficial to the user in a card not present scenario. Furthermore, the user may initiate the payment transaction in a public space and upload the encrypted image on the merchant portal without the risk of leaking payment account information to someone near to the user who can see what the user is typing/tracing.

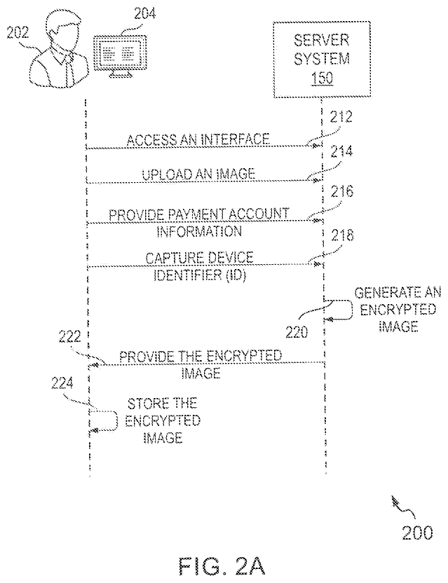

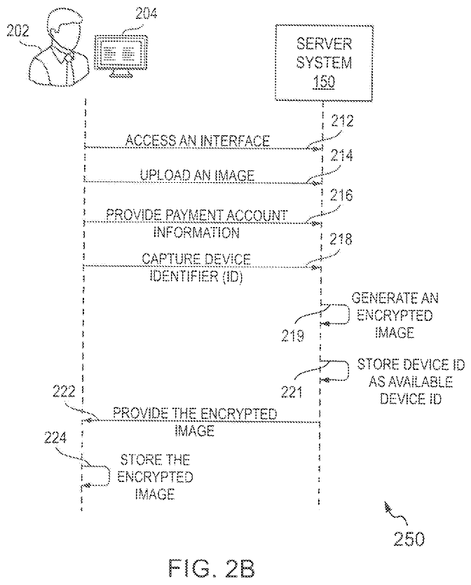

FIG. 2A shows a representation of a sequence flow 200 for illustrating a generation of an encrypted image for use in processing payment transactions, in accordance with an example embodiment of the present disclosure. In at least one embodiment, the generation of the encrypted image, as will be explained in further detail later, is a one-time activity for each device used by the user. The user may then use the generated encrypted image to make a plurality of payments.

The generation of the encrypted image is performed by a server system 150 associated with a payment network. In one embodiment, the server system 150 corresponds to a server associated with the merchant, for example, the acquirer server 130 or a server associated with a payment gateway. For example, a retail enterprise (i.e. the merchant) extending the facility to make payments using encrypted images may enable users to generate respective encrypted images. To that effect, a server associated with a bank of the retail enterprise (i.e. the acquirer server 130) may facilitate reception of payment account information and perform subsequent generation of the encrypted image. Similarly, a server associated with a third-party payment gateway or the payment server 140 associated with a payment interchange network (such as that associated with Mastercard®) may facilitate reception of payment account information and perform subsequent generation of the encrypted image. The acquirer server, the third-party payment gateway server and/or the payment server 140 may also extend image encryption/decryption as a Web service to other servers, such as one or more issuer servers.

In one embodiment, the server system 150 corresponds to the issuer server 135. More specifically, the issuer (i.e. the bank) associated with a user may facilitate generation of the encrypted image, using a server associated with the bank (i.e. the issuer server 135). In some example scenarios, the issuer server 135, the acquirer server 130 and the payment server 140 can be a single entity, or any two of these servers may be a single entity, configuring the server system 150. The terms ‘server system’, ‘server’ or ‘system’ are used interchangeably hereinafter.

In one embodiment, the server system 150 provides an application (also referred to as ‘image encryption application) or an online portal/website to users to request generation of respective encrypted images. The user may access the online portal/website or download/install a thin client or an instance of the image encryption application on to a device associated with the user. The sequence flow diagram 200 starts at 212.

At 212, a user 202 using a device 204 accesses an interface provided by the server system 150. The interface may correspond to an image encryption application interface or an online/Web portal interface associated with the server system 150. In at least one embodiment, the interface provides an option to generate an encrypted image to the user 202 subsequent to the user access of the interface. The option to generate an encrypted image may be associated with a request to the user 202 to provide an image and payment account information.

At 214, the user 202 uploads an image using the interface. The user 202 may select any image that is already stored/available in the device 204 and upload the image on the interface.

At 216, the user 202, using the device 204, provides payment account information on the interface. In one illustrative example, the user 202 may provide bank account information, such as the name of the bank in which the user 202 has maintained a payment account (i.e. the payment account from which the payments to the merchant are to be debited), the bank location, the user bank account number, and the like. In another illustrative example, the user 202 may provide payment card information, such as for example, information related to a credit card, a debit card or any banking card on the interface. The payment card information entered using the device 204 includes, but is not limited to, payment card number, date of expiry, Card Verification Value (CVV) details, and the like.

For purposes of the description, the image and the payment account information provided on the interface by the user 202 configures an ‘encrypted image generation request. Further, as the payment account information is used for payment transactions, the payment account information is also referred to herein as payment transaction information.

At 218, the server system 150 captures a device identifier (ID) from the device 204, which is used to access the interface. The device ID is captured from the device in response to the receipt of the encrypted image generation request. It is noted that the ‘device ID’ is an application-independent identifier unique to the respective electronic device, such as the device 204. The device ID may be captured from the information exchanged as part of a communication session between the device 204 and the server system 150. In one embodiment, if the device 204 is a smartphone, then the device ID may correspond to one of International Mobile Equipment Identity (IMEI), Mobile Equipment IDentifier (MEID), Electronic Serial Number (ESN), International Mobile Subscriber Identity (IMSI), etc. In one embodiment, if the device 204 includes a Wi-Fi or Bluetooth hardware, then the device ID may correspond to a Media Access Control (MAC) ID.

At 220, the server system 150 generates an encrypted image using a steganographic encryption process. More specifically, the server system 150 is configured to tokenize the payment transaction information and encrypt the device ID and the payment transaction information using a steganographic encryption process. In an embodiment, a steganographic encryption process is configured to use binary representation of colors of the pixels associated with the image provided by the user 202 to conceal the device ID and the payment transaction information for generating the encrypted image. For example, the steganographic encryption process may involve extraction of binary representations of colors configuring the pixels, which are located at predetermined locations. The least significant bits (LSBs) of binary representations may be manipulated (for example, the LSBs may be flipped) in a predetermined way to conceal the device ID and the payment transaction information in the image to generate the encrypted image using steganography. In an example embodiment, the device ID may be encrypted as part of a first layer of encryption, and the payment transaction information may be encrypted as a second layer of encryption. For instance, the device ID may be encrypted in a first pre-defined number of pixels in the centre of the image and the payment transaction information may be encrypted in a second pre-defined number of pixels in each of the corners of the image.

Subsequent to the generation of the encrypted image, at 222, the server system 150 provides the encrypted image to the device 204.

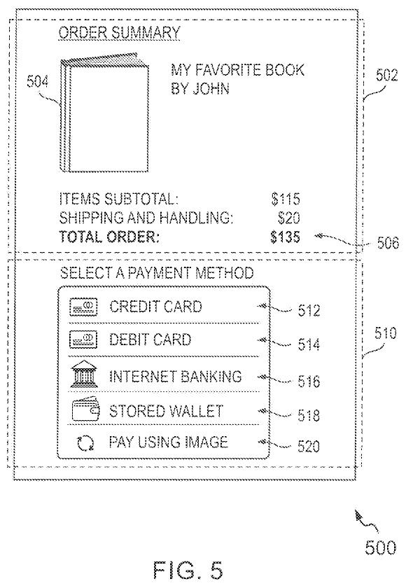

At 224, the device 204 stores the encrypted image in an internal storage associated with the device 204. The stored encrypted image may be used for providing payment transaction information on merchant checkout pages as will be explained later with reference to FIGS. 4 and 5. The sequence flow 200 ends at 224.

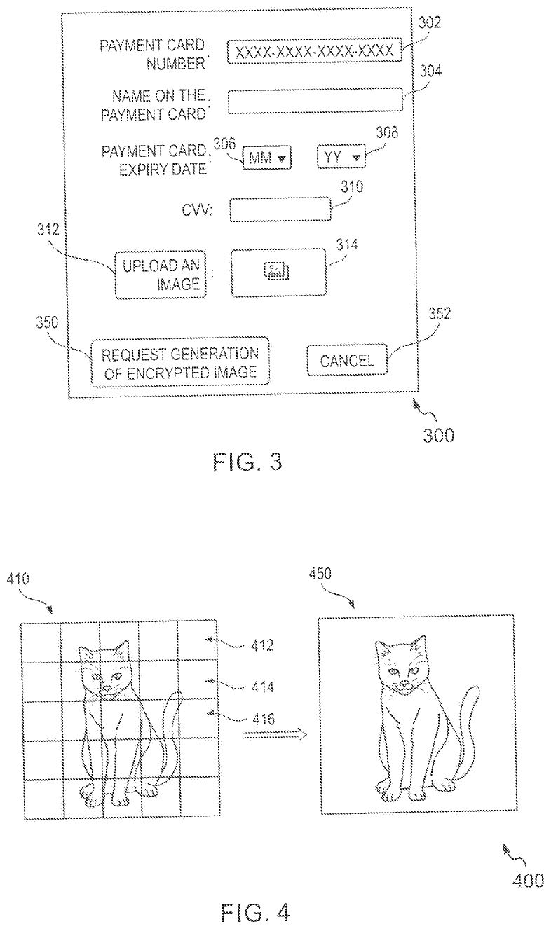

As explained above, subsequent to the access of the interface associated with the server system 150, the user 202 may be provided with an option to request generation of an encrypted image. An example User Interface (UI) including such an option is shown in FIG. 3.

In another embodiment, the encrypted image may not contain the device ID, and only the at least one payment transaction information is encrypted in the image provided by the user using at least one steganographic encryption process. However, in this embodiment, when the user send the encrypted image generation request, the device ID is also captured from such request as part of script of the payment page or any using any technique as per the communication protocol. For instance, the communication from the user device to the server system may have details of the sender entry i.e. the user device, and such details may be the device ID of the user device. Alternatively or additionally, the user may specifically provide the device ID along with the encrypted image generation request. The captured device ID is stored as the available device ID for the user device with the server. One example representation of a flow diagram 250 according to this embodiment is described with reference to FIG. 2B.

Operations 212 to 218 as shown in FIG. 2B are same as described with reference to FIG. 2A. At operation 219, the server system 150 generates an encrypted image using a steganographic encryption process. More specifically, the server system 150 is configured to tokenize the payment transaction information and encrypt the payment transaction information using a steganographic encryption process.

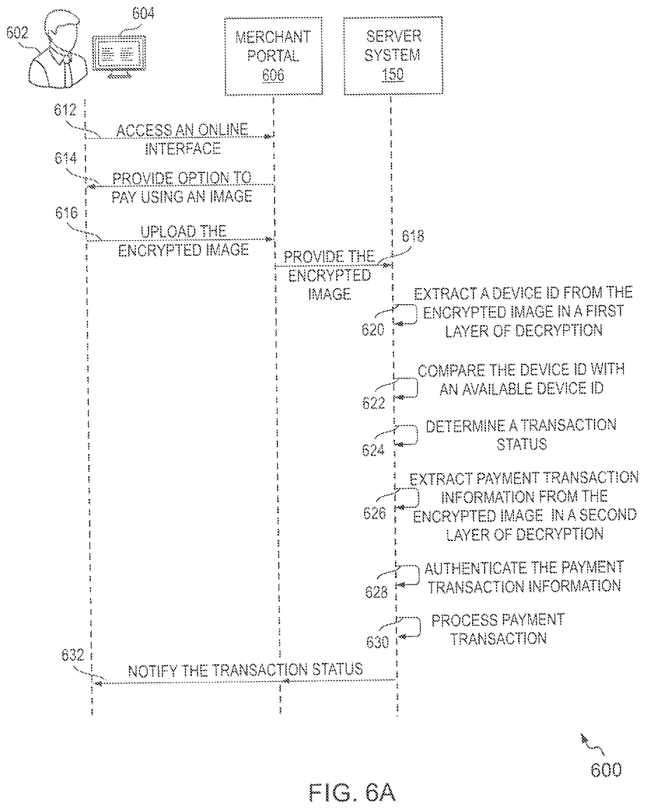

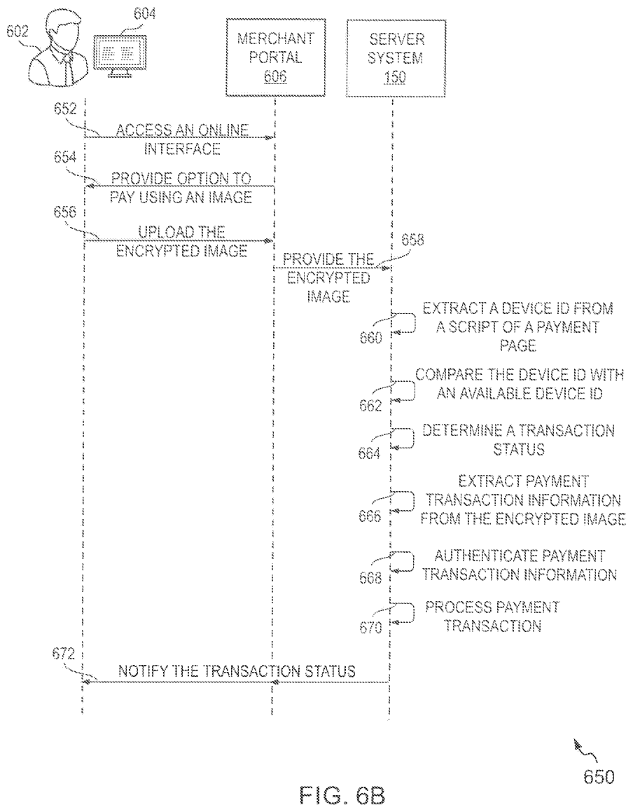

At operation 221, the server system 150 is configured to store the device ID as the available device ID for the device of the user. The available device ID is used for authentication during an actual payment transaction initiated by the device of the user, as described with reference to FIG. 6B. Thereafter, operations 222 and 224 are performed as described with reference to FIG. 2A, where the encrypted image is provided to device 204, and the device 204 stores the encrypted image in an internal storage associated with the device 204.

Referring now to FIG. 3, an example UI 300 is shown for illustrating a provisioning of an encrypted image generation request by a user, in accordance with an example embodiment of the present disclosure. As explained with reference to FIG. 2A, the server system 150 is configured to facilitate generation of the encrypted image for use in payment transactions to merchants. Further, as explained with reference to FIG. 2A, the server system 150 provides an image encryption application and/or a Website/online portal for enabling the users to request generation of respective encrypted image. The UI 300 shown in FIG. 3 corresponds to an UI associated with such an application or the Website/online portal, which is displayed to a user (like the user 202 of FIG. 2A) subsequent to the user access of the image encryption application or Website/online portal.

The UI 300 is depicted to include a plurality of form fields requesting the user to provide information related to the user payment account. The form fields are depicted to request the user to provide information related to a payment card, for illustration purposes. It is noted the form fields may, additionally or alternatively, be configured to request bank account related information from the user. In at least one embodiment, a UI including form fields requesting payment card information or bank account information may be displayed to the user based on the user's selection of a payment transaction option for executing payment transactions to merchants.

The UI 300 is depicted to display a plurality of form fields, such as form fields 302, 304, 306, 308 and 310 for receiving input related to the user's payment card. Each form field from among the form fields 302-310 is capable of receiving a user input (for example, a text input or a selection input). For example, the form field 302 is depicted to be associated with text ‘PAYMENT CARD NUMBER’. The user may provide a 16-digit numerical input corresponding to the payment card number (for example, a debit card or a credit card) in the form field 302. In one embodiment, the form field 302 may be capable of receiving input in form of ‘XXXX-XXXX-XXXX-XXXX’, where ‘X’ corresponds to a positive integer. In one embodiment, the user may sequentially input the digits of the payment card number and the form field 302 may be configured to align the numbers in the form, depicted above. In some embodiments, the UI 300 may also include another form field, such as the form field 302, requesting the user to reconfirm the payment card number and the UI 300 may be configured to display an error flag if the payment card number entered in the two form fields do not match.

The form field 304 is depicted to be associated with text ‘NAME ON THE PAYMENT CARD’ and the user may provide a string of alphabets corresponding to the name of the individual displayed on the payment card in the form field 304. The form fields 306 and 308 are depicted to be associated with text ‘PAYMENT CARD EXPIRY DATE’, and the user may provide a selection input corresponding to the month and year of the expiry of the payment card displayed on the payment card in the form fields 306 and 308, respectively.

The form field 310 is depicted to be associated with text ‘CVV’. The form field 310 may be configured to receive a 3-digit numerical input corresponding to the Card Verification Value (CVV) of the payment card. In one embodiment, the form field 310 may be capable of receiving user input in form of ‘YYY’, where ‘Y’ corresponds to a positive integer.

The UI 300 is further depicted to display a button 312 associated with text ‘UPLOAD AN IMAGE’. The user may select the button 312 to navigate to any image stored (i.e. available within the device) and thereafter select the image to initiate an uploading of the image. An example thumbnail 314 associated with the uploaded image is shown for illustration purposes. It is noted that the image may be any image that is readily available to the user device, for example, an image already stored with the user device, an image instantly captured or received from an external source such as the Internet or flash drive or similar storage. Further, it should also be appreciated that the image is different as compared to a QR code or any machine readable code, and advantageous as such image offers a convenience to the users, as the users can select any image as per their preference. Further, once the payment transaction information and/or device ID are encrypted in the image, such information is not discernible to any onlookers.

It is noted that the information provided in the form fields 302-310 by the user configures the payment transaction information for the purposes of the description. More specifically, the user input in the form fields for payment card number, name on the card, payment card expiry details and CVV configure the payment transaction information.

The user may select a button 350 exemplarily depicted to display text ‘REQUEST GENERATION OF ENCRYPTED IMAGE’ to provide confirmation of the information included in the form fields 302-310. Alternatively, the user may select a button 352 associated with text ‘CANCEL’ to cancel the provisioning of the request to generate the encrypted image.

Upon selection of the button 350, in some embodiments, the server system 150 is configured to communicate with card issuer (or the issuer server 135) to validate the user payment account information. In case, the user has provided a banking accounting information (for example, a savings account or a current account), then the server system 150 may provision the information related to the banking account to a user's bank, for validation of the account information. More specifically, the server system 150 may provide the information to a server associated with the user bank over a payment network, such as the payment network 145. The issuer server 135 or the user's bank may perform user authentication using any 3D secure (3DS) authentication means, such as a One-Time Password (OTP) for instance. For example, the OTP may be sent to the registered Email address or the registered phone number to validate the user identity. It is noted that, in some embodiments, the validation of the payment account details may be skipped and the details included in the encrypted image may be validated at the time of processing of the payment transactions.

As explained with reference to FIG. 2A, in response to a receipt of encrypted image generation request, the server system 150 captures a device ID of the device used by the user to access the UI 300. The capturing of the device ID may be performed as explained with reference to FIG. 2A and is not explained again herein. Further, the server system 150 is configured to tokenize the payment transaction information and encrypt the device ID and the payment transaction information using at least one steganographic encryption process into the uploaded image to generate the encrypted image.

FIG. 4 shows a representation 400 for illustrating a generation of an encrypted image 450, in accordance with an example embodiment of the present disclosure. As explained with reference to FIGS. 2A-2B and 3, a user may upload an image stored/available in the device. The uploaded image may then be encrypted to include device ID and the payment transaction information to generate the encrypted image.

It is understood that an image is configured of a large number of pixels. The number of pixels in the image defines a resolution of the image. For example, an image that is 2048 pixels wide and 1536 pixels high (2048×1536) contains 3,145,728 pixels, i.e. a resolution of such an image is 3.1 Megapixels. The pixels in the image may be associated with various colors. Each color may be represented using three color channels, i.e. a ‘Red’ color channel, a ‘Green’ color channel and a ‘Blue’ color channel in a Red-Green-Blue (RGB) color scheme. It is noted that the various colors may also be represented using a Cyan-Magenta-Yellow-Black (CMYK) scheme by subtracting RGB color values from white light. Each color of the pixel may be represented by 8 bits (or one byte). Accordingly, the maximum number that 8 bits can represent is 255 and the minimum is zero. In an illustrative example, a pixel associated with a dark green color may be represented in RGB values as Red: 82, Green: 154, and Blue: 102. Accordingly, a binary representation of such a dark green pixel may be 01010010 (red), 10011010 (green), and 01100110 (blue). It is noted that each pixel may be associated with such a corresponding binary representation.

In an example scenario, the user may have uploaded an image 410 on a UI, such as the UI 300 explained with reference to FIG. 3. For illustration purposes, the image 410 is depicted to be divided into 25 blocks with each block representing a pixel. More specifically, the image 410 includes 25 pixels (i.e. the image 410 is 5 pixels wide and 5 pixels high). It is understood that each block shown in the image 410 may itself include several pixels and the overall image 410 may include a very large number of pixels, however, for the purposes of description, each block is assumed to represent one pixel. As explained above, each pixel may be associated with a color (not shown in FIG. 4) and the color may be represented using RGB values. As an illustrative example, a pixel 412 may be associated with values of red: 6, green: 250 and blue: 7 (i.e. the pixel is a shade of green); a pixel 414 may be associated with values of red: 241, green: 252 and blue: 23 (i.e. the pixel is a shade of yellow); a pixel 416 may be associated with values of red: 6, green: 250 and blue: 7 (i.e. the pixel is a shade of white) and so on and so forth.

In one embodiment, the server system 150 is configured to tokenize the payment transaction information and encrypt the device ID and the payment transaction information using at least one steganographic encryption process. In an embodiment, a steganographic encryption process is configured to use binary representation of colors of the pixels associated with the image to conceal the device ID and the payment transaction information for generating the encrypted image.

For example, the steganographic encryption process may involve extraction of binary representations of colors configuring the pixels, which are located at predetermined locations. For example, every 5^{th} pixel in the image may be chosen for concealing the user's information. Accordingly, a binary representation of every 5^{th} pixel may be extracted. Example pixels at the 5^{th} location in the image 410 are pixels 412, 414, 416 and so on and so forth. The binary representations corresponding to these pixels may be extracted. For example, the binary representation of the pixel 412 with RGB values of 6, 250 and 7 is (00000110, 11111010, 00000111). In one embodiment, the least significant bits (LSBs) of binary representations may be manipulated in a predetermined way to conceal the device ID and the payment transaction information in the image to generate the encrypted image using steganography. For example, the last bit (i.e. last LSB) of each color value for a pixel may be changed to reflect a digit of information. For example, if the user's payment card starts with the digit ‘5’, then the binary representation of ‘5’ may be ‘101’. In the binary representation of the pixel 412, the last bit of each color configures a number ‘001’. Accordingly, the last bit of binary representation of the red color of the pixel 412 may be flipped from ‘0’ to ‘1’, such that the last bits of red, green and blue colors, when taken together configure the sequence ‘101’ representing ‘5’, i.e. the first digit of the user's payment card. Accordingly, the digits (or even alphabet characters) from the device ID and the payment transaction information may be extracted and concealed within the LSB of binary representations of the pixel colors to generate an encrypted image, such as the encrypted image 450. It is noted that manipulating an LSB of one or more colors constituting a pixel may not change the appearance of the pixel and as such no noticeable difference may be visible to a viewer of the images 410 and 450. It is noted that an example steganographic encryption process involving concealing information in LSBs of pixel colors of every 5^{th} pixel is described herein for illustration purposes. Indeed, pixels at any predetermined locations may be selected for concealing the payment transaction information and the device ID. Further, manipulating the LSB is also mentioned herein for illustration purposes. Indeed, the pixel information (and not necessarily binary information of the pixel colors) may be manipulated in several ways for concealing the payment transaction information and the device ID. As explained above, an encrypted image, such as the encrypted image 450, may be used for making payments to merchants as will be explained in detail with reference to FIGS. 5 and 6A-6B.

FIG. 5 shows a representation of a UI associated with a merchant checkout page for illustrating the use of encrypted images in processing payment transactions, in accordance with an example embodiment of the present disclosure.

In an example scenario, a user may wish to purchase a product being displayed on an online merchant portal and, accordingly, the user may add the product to a purchase cart and proceed to the checkout page on the merchant portal. It is noted the checkout page on the merchant portal may be associated with a payment gateway (or payment network) capable of facilitating processing of payment transactions. In at least one example embodiment, the checkout page may be configured to provide an option to pay using an encrypted image. The provisioning of such a payment option is shown using an example UI 500 associated with a merchant checkout page. In the illustrative example, the merchant may correspond to an online book retailer. It is noted that the type of online merchant may not be limited to online book retailers and, that the user may purchase products or avail services from a variety of online sellers of goods and services.

The user may wish to purchase a book from the online book retailer and accordingly may add an item to the shopping cart and proceed to the checkout page, such as the checkout page shown using the UI 500. The checkout page is generally configured to provide a summary of the items selected for purchase by the user, a total cost of purchasing the one or more items and one or more payment options to pay the merchant. Accordingly, the UI 500 is depicted to include an order summary section 502 displaying a book 504 and a total cost 506 of purchasing the book 504. The book 504 is depicted to be titled as ‘MY FAVORITE BOOK’ for illustration purchases. Similarly, the total cost 506 of purchasing the book is exemplarily depicted to be 135 $ (US Dollars). The UI 500 is further depicted to include a section 510 displaying several options for payment for the intended purchase of the book 504. More specifically, the section 510 is depicted to display options 512, 514, 516, 518 and 520 associated with text ‘CREDIT CARD’, ‘DEBIT CARD’, ‘INTERNET BANKING’, STORED WALLET′ and ‘PAY USING IMAGE’, respectively. Accordingly, the user may select any of the options and initiate payment to the merchant. The option 520 provided by the merchant corresponds to the option to pay using an encrypted image. The user may select the option 520 and thereafter be directed to a UI requesting the user to upload the encrypted image.

In at least one example embodiment, the server system 150 may be configured to receive the encrypted image uploaded by the user on the merchant portal. As explained above, the encrypted image includes the device ID and at least one payment transaction information associated with a payment account of the user. The server system 150 may be configured to extract the device ID and the at least one payment transaction information from the encrypted image. Further, the server system 150 may also be configured to capture the device ID of the device used to connect to the merchant portal, for example, from the communication session established between the device of the user and merchant portal/payment gateway. The server system 150 may be configured to compare the captured device ID with the device ID extracted from the encrypted image. Subsequent to successful matching of the extracted device ID with the available device ID (i.e. the captured device ID), the server system 150 may be configured to process the payment transaction using the payment account based on the payment transaction information, i.e., based on the bank account information or the payment card information extracted from the encrypted image.

In one embodiment, the server system 150 may correspond to a server associated with the payment gateway. In such a scenario, subsequent to the successful matching of the device ID, the server associated with the payment gateway may be configured to provide the payment transaction information to the appropriate issuing bank (i.e. the issuer or the bank associated with the issuance of the payment card or the bank account of the user). A server associated with the issuer, also known as the issuer server 135, may be configured to authenticate the payment transaction information and upon successful match of the payment transaction information with the stored values of the payment transaction information, initiate a transfer of funds from the user's payment account to the merchant payment account.

FIG. 6A shows a representation of a sequence flow 600 for illustrating a processing of a payment transaction with an encrypted image, in accordance with an example embodiment of the present disclosure. The processing of the payment transaction using the encrypted image is performed by the server system 150 (shown in FIG. 2A) associated with a payment network. The sequence flow 600 starts at 612.

At 612, a user 602 using a device 604 accesses an online interface associated with a merchant portal 606. The user 602 may further select an item for purchase and proceed to the checkout page associated with the merchant portal 606.

At 614, the merchant portal 606 provides an option (such as the option 520 shown in FIG. 5) to pay using an encrypted image to the user 602 on the checkout page.

At 616, the user 602 accepts the option to pay using the encrypted image and uploads the encrypted image on the merchant portal 606.

At 618, the merchant portal 606 provides the encrypted image to the server system, such as the server system 150.

At 620, the server system 150 extracts the device ID in a first layer of decryption of the encrypted image.

At 622, the server compares the device ID extracted from the encrypted image with an available device ID of the device 604. In an embodiment, the available device ID is already known to the server system 150. Alternatively or additionally, the available device ID can also be obtained from a script of the payment page which is a part of current communication between the device 604 and the server system 150.

At 624, the server system 150 determines if the transaction is approved or not based on the result of the comparison at operation 622. More specifically, if the result of the comparison of the device IDs is a success, then the transaction is determined to be approved. If the result of the comparison of the device IDs fails, then the transaction is determined to be declined.

If the comparison of the device IDs is successful, at 626, the server system 150 extracts the payment transaction information in a second layer of decryption of the encrypted image. Once the payment transaction information is extracted, the server system 150 may be caused to facilitate authentication of a validity of the payment transaction information extracted from the encrypted image at 628. Upon successful authentication, at 630, the server system 150 may process the payment transaction i.e. cause transfer of funds from the user's payment account (identified using the payment transaction information) to the merchant's payment account to complete the processing of the payment transaction. The server system 150 notifies the status of the transaction to the merchant portal 606 and the device 604 at 632. The sequence flow 600 ends at 632.

The use of encrypted images in processing payment transactions is so far explained with reference to encrypting payment transaction information in form the user's payment account. However, in some embodiments, the encrypted images may also be used to facilitate user authentication as part of processing payment transactions from users to merchants. More specifically, the payment transaction information in form of a one-time password (OTP) may be encrypted along with the user's device ID to generate the encrypted image and, such an encrypted image may be used to authenticate the user as will be explained hereinafter.

In some embodiments where the device ID is not encrypted within the image provided by the user, an example representation of processing of a payment transaction is shown in FIG. 6B. FIG. 6B shows a representation of a sequence flow 650 for illustrating a processing of a payment transaction with an encrypted image, in accordance with another example embodiment of the present disclosure. The processing of the payment transaction using the encrypted image is performed by the server system 150 (shown in FIG. 2B) associated with a payment network. The sequence flow 650 starts at 652.

At 652, a user 602 using a device 604 accesses an online interface associated with a merchant portal 606. The user 602 may further select an item for purchase and proceed to the checkout page associated with the merchant portal 606.

At 654, the merchant portal 606 provides an option (such as the option 520 shown in FIG. 5) to pay using an encrypted image to the user 602 on the checkout page.

At 656, the user 602 accepts the option to pay using the encrypted image and uploads the encrypted image on the merchant portal 606. The encrypted image may be an example of the encrypted generated as per the process described with reference to FIG. 2B.

At 658, the merchant portal 606 provides the encrypted image to the server system, such as the server system 150.

At 660, the server system 150 extracts the device ID from a communication associated with encrypted image between the device of the user and the server system. For example, the server system, using the script of the payment page which is a part of the communication, extracts the device ID. In another example, the user may also separately provide the device ID along with the encrypted image.

At 662, the server system 150 compares the extracted device ID with an available device ID of the device. In an embodiment, the available device ID is already stored with the server system 150, as described with reference to FIG. 2B (see, operation 221).

At 664, the server system 150 determines if the transaction is approved or not based on the result of the comparison at operation 662. More specifically, if the result of the comparison of the device IDs is a success, then the transaction is determined to be approved. If the result of the comparison of the device IDs fails, then the transaction is determined to be declined.

If the comparison of the device IDs is successful, at 666, the server system 150 extracts the payment transaction information from a decryption of the encrypted image. Once the payment transaction information is extracted, the server system 150 may be caused to facilitate authentication of a validity of the payment transaction information extracted from the encrypted image at 668. Upon successful authentication, at 670, the server system 150 may process the payment transaction i.e. cause transfer of funds from the user's payment account (identified using the payment transaction information) to the merchant's payment account to complete the processing of the payment transaction. The server system 150 notifies the status of the transaction to the merchant portal 606 and the device 604 at 672. The sequence flow 600 ends at 672.

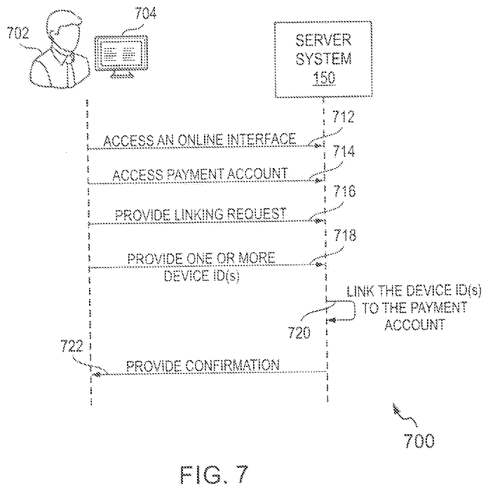

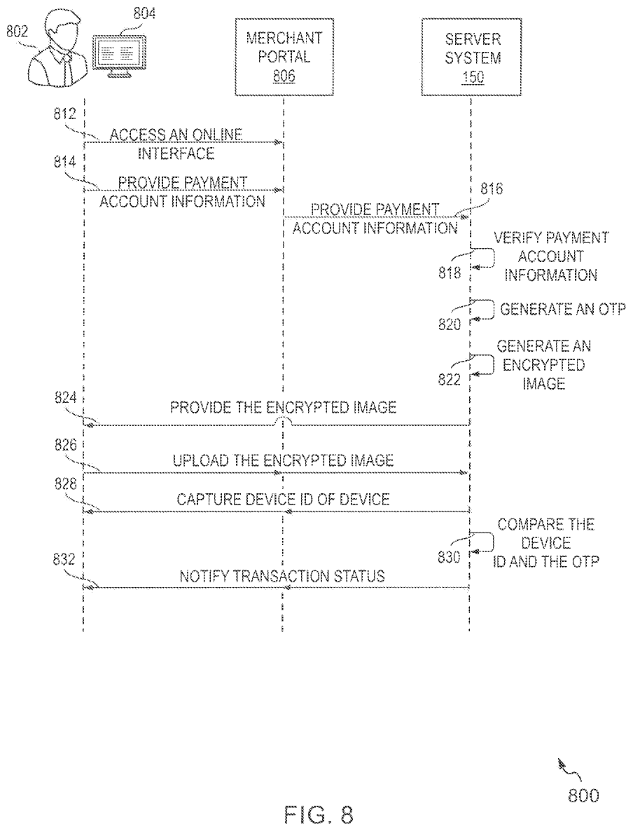

In some example scenarios, a user may link one or more devices with a user's payment account. The linking process may involve providing device identifiers (IDs) of the one or more devices to the issuer, which may store the device IDs along with the user's payment account information, such as for example, the user's bank account information or the user's payment card information. The stored information may be used to generate an encrypted image and facilitate processing of payment transactions as will be explained with reference to FIGS. 7 and 8.

FIG. 7 shows a representation of a sequence flow 700 for illustrating a linking of one or more device IDs with a user's payment account, in accordance with an example embodiment of the present disclosure. The sequence flow 700 starts at 712.

At 712 of the sequence flow 700, a user 702 using a device 704 accesses an online interface of the server system 150 (explained with reference to FIGS. 2A-2B to 6A-6B). In the sequence flow 700 explained herein, the server system 150 may correspond to an issuer server (i.e. a server associated with a bank in which the user 702 has maintained a payment account) or the payment server 140.

At 714, the user 702 using the device 704, accesses the user's payment account (for example, a banking account or a payment card account) maintained at the server system 150.

At 716, the user 702 provides a request to the server system 150 to link one or more device IDs to the user's payment account.

At 718, the user 702 provides the one or more device IDs to the server system 150. In some embodiments, the server system 150 may also be configured to capture a device ID of the device 704 used by the user for accessing the online interface of the server system 150.

At 720, the server system 150 links the device ID(s) to the user's payment account. It is noted that the linking of the device ID(s) to the user's payment account may involve making an entry of the device ID(s) in a database location associated with the user's payment account.

At 722, the server system 150 provides a confirmation of the successful linking of the device ID(s) to the user 702. The sequence flow 700 ends at 722.

In at least one example embodiment, subsequent to the linking of the device ID(s) to the user's payment account, if the user 702 initiates a payment to a merchant on a merchant portal and provides, for example, a payment card information, then the server system 150 may first configured to match the payment card information entered by the user 702 on the merchant portal with available payment card information. If the payment card information matches, then the server system 150 may be configured to generate a one-time password (OTP) and encrypt the OTP with at least one device ID in an image using steganographic encryption process to generate an encrypted image. The encryption of payment transaction information (i.e. the OTP in this case) and the device ID in an image using steganography is explained with reference to an illustrative example in FIG. 4 and is not explained again herein.

The server system 150 may further be configured to provide the encrypted image to the user 702. In an example embodiment, the encrypted image may be sent to the user 702 using an Email medium to the user's registered Email ID, or, the encrypted image may be sent to the user 702 using a messaging medium (for example, Short Message Service (SMS)) to the user's registered phone number. The user 702, subsequent to receiving the encrypted image, may upload the encrypted image on the merchant portal to authenticate a personal identity. The server system 150 may be configured to capture (or cause capture of) the device ID used by the user for uploading the image and compare the device ID with the device ID extracted from the uploaded image. On successful match of the device IDs, the OTP may be matched with available OTP at the issuer server 135. Subsequent to the successful match, the user identity may be authenticated and the issuer server 135 may initiate a transfer of funds from the user's payment account to the merchant payment account. The matching of the OTP and the device ID provides two levels of authentication for processing of payments from users to the merchants. An example sequence flow associated with the processing of payment transaction based on the encrypted image is explained with reference to FIG. 8.

FIG. 8 shows a representation of a sequence flow 800 for illustrating a processing of a payment transaction with an encrypted image, in accordance with an example embodiment of the present disclosure. The sequence flow 800 starts at 812.

At 812, a user 802 using the device 804, accesses an online interface of the merchant portal 806 and selects an item to be purchased.

At 814, the user 802 provides payment account information (i.e. banking account or payment card information) on the merchant portal 806 to initiate a payment for the item to be purchased.

At 816, the merchant portal 806 provides the payment account information to the server system 150.

At 818, the server system 150 verifies the payment account information with available payment account information.

At 820, subsequent to successful match of the payment account information, the server system 150 generates a one-time password (OTP).

At 822, the server system 150 encrypts the OTP and a device ID (for example device ID of the device 804) linked to the user's payment account in an image to generate an encrypted image. It is noted the image may be selected from a repository of images stored/available at the server system 150.

At 824, the server system 150 provides the encrypted image to the user 802. The encrypted image may be provided to the user 802 on the user's registered phone number or registered Email ID.

At 826, the user 802 using the device 804 uploads the encrypted image on the payments page of the merchant portal (i.e. a Web page associated with a payment network linked with the server system 150).

At 828, the server system 150 causes capture of the device ID of the device 804 used for uploading the image from a script of payment page. In an embodiment, the instead of capturing the device ID at 828, the server system 150 accesses the available device ID stored with the server system 150, where the available device ID is tagged with the device of the user.

At 830, the server system 150 compares the device ID and the OTP included in the encrypted image with the device ID of the device 804 and the OTP available with the server system 150. The operation of step 830 is performed in two layers. For instance, in first layer of decryption, the device ID is extracted, and compared with the available device ID. Only if the extracted device ID matches with the available device ID, a second layer of decryption is performed on the encrypted image to extract the OTP. Hence, if any the extracted device ID and the available device ID do not match, then the server system 150 is configured to decline the payment transaction.

Once the OTP is extracted, the OTP is matched with the available OTP. On successful matching the OTP, the server system 150 approves the transaction and processes the transaction. More specifically, the server system 150 facilitates the transfer of funds from the user's payment account to the merchant's payment account.

At 832, the server system 150 notifies a transaction status of the payment transaction to the merchant portal 806 and the device 804. The sequence flow 800 ends at 832.

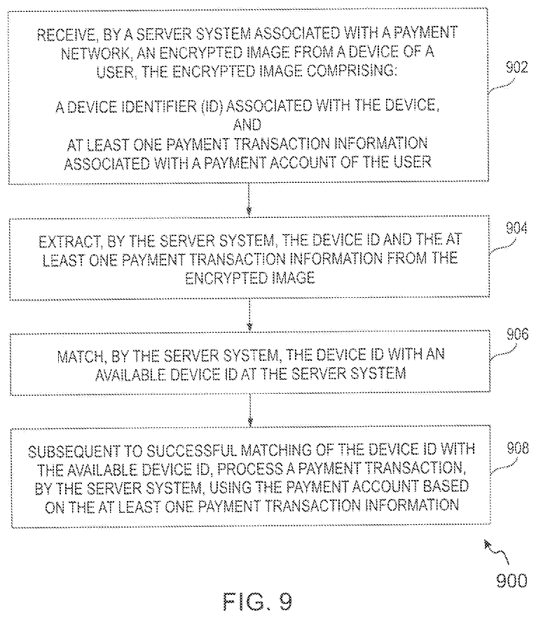

FIG. 9 illustrates a flow diagram of a method 900 for illustrating a processing of a payment transaction with an encrypted image, in accordance with an example embodiment of the present disclosure. The method 900 depicted in the flow diagram may be executed by, for example, a server system such as the server system 150 explained with reference to FIGS. 2A-2B and 8. Operations of the flow diagram 900, and combinations of operation in the flow diagram 900, may be implemented by, for example, hardware, firmware, a processor, circuitry and/or a different device associated with the execution of software that includes one or more computer program instructions.

In one embodiment, the method 900 in the flow diagram may be executed by a server system associated with a merchant bank or a payment server associated with a payment network, such as the Mastercard® payment system interchange network. It is noted that the operations of the method 900 can be described and/or practiced by using other server systems, such as the acquirer server 130 or the issuer server 135 shown in FIG. 1. The method 900 starts at operation 902.

At 902, the method 900 includes receiving an encrypted image from a device of a user by a server system associated with a payment network. The encrypted image includes a device identifier (ID) associated with the device, and at least one payment transaction information associated with a payment account of the user.

As explained with reference to FIGS. 2A-2B and 3, a user may access an interface associated with a server system and provide a request for generating an encrypted image. The encrypted image generation request may include an image available in the device of the user and at least one payment transaction information associated with a payment account of the user. In one illustrative example, the payment transaction information may include a bank account related information or a payment card information associated with the payment account of the user. More specifically, the user may provide either a bank account information, such as a user bank account number, a bank ID, a bank location, etc., or a payment card information, such as information related to a credit card, a debit card or any such banking card linked to the payment account of the user.

In response to the encrypted image generation request, the server system is configured to capture the device ID of the device from which the request is received and encrypt the payment transaction information (i.e. the payment card information or the bank account information) and the device ID in the image to generate the encrypted image. In one embodiment, the server system is configured to tokenize the payment transaction information and encrypt the device ID and the payment transaction information using at least one steganographic encryption process. The generation of the encrypted image using steganography may be performed as explained with reference to FIG. 4 and is not explained again herein. Subsequent to the generation of the encrypted image, the server system provides the encrypted image to the device. The device may be configured to store the encrypted image in an internal storage associated with the device.

In an example scenario, the user may initiate a payment to a merchant on a merchant portal. For example, the user may wish to purchase a product being displayed on the merchant portal, and, accordingly, the user may add the product to a purchase cart and proceed to the checkout page on the merchant portal. In at least one example embodiment, the checkout page may be configured to provide an option to pay using an encrypted image. An example UI showing the checkout page offering the option to pay using an image is shown in FIG. 5.

The user may select the option to pay using the encrypted image and upload the encrypted image on the checkout page. In at least one example embodiment, the server system may be configured to receive the encrypted image uploaded by the user on the merchant portal.

It is noted that in some embodiments, instead of uploading the encrypted image on the checkout page, the user may provide an input related to the payment account information, such as for example, a payment card information. The server system may be configured to match the payment card information entered by the user on the merchant portal with available payment card information. If the payment card information matches, then the server system may be configured to generate a one-time password (OTP). The server system may then be configured to encrypt the OTP with a device ID associated with a user in an image using steganographic encryption process to generate an encrypted image. The server system may further be configured to provide the encrypted image to the user on the device associated with the device ID encrypted in the image. The user, subsequent to receiving the encrypted image, may upload the encrypted image (including the OTP) on the merchant portal to authenticate a personal identity. The server system may receive the encrypted image including the payment transaction information in form of the OTP, and the device ID.

At 904 of the method 900 includes extracting, by the server system, the device ID and the at least one payment transaction information from the encrypted image. More specifically, in case of the payment account information being included in the encrypted image as the payment transaction information, the server system extracts the payment account information and the device ID from the encrypted image. In case of the OTP being included in the encrypted image as the payment transaction information, the server system extracts the OTP and the device ID from the encrypted image.

At 906, the method 900 includes matching, by the server system, the device ID with an available device ID at the server system.

Subsequent to successful matching of the device ID with the available device ID, at 908, the method 900 includes processing a payment transaction by the server system based on the at least one payment transaction information. More specifically, the server system may be configured to process the payment transaction based on the at least one payment transaction information, i.e., based on the bank account information or the payment card information extracted from the encrypted image. In at least one embodiment, subsequent to successful matching of the device ID with the available device ID, the server system 150 may initiate a transfer of funds from the user's payment account to the merchant payment account.

In scenarios, where the encrypted image includes the OTP, on successful match of the device IDs, the OTP may be matched with available OTP at the server system. Subsequent to the successful match, the user identity may be authenticated and the server system may facilitate a transfer of funds from the user's payment account to the merchant payment account. The matching of the OTP and the device ID provides two levels of authentication for processing of payments from users to the merchants.

The method 900 ends at 908.

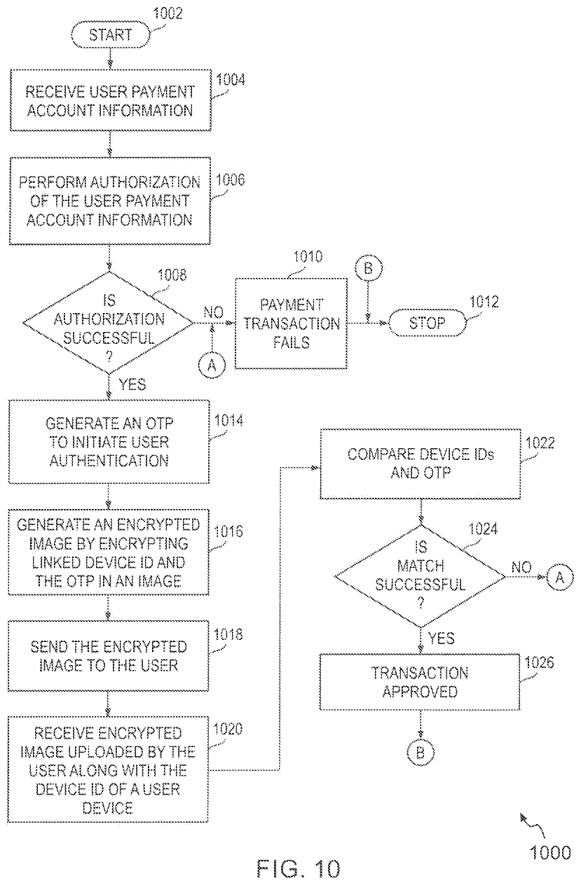

FIG. 10 illustrates a flow diagram of a method 1000 for illustrating a processing of a payment transaction with an encrypted image, in accordance with an example embodiment of the present disclosure. The method 1000 depicted in the flow diagram may be executed by, for example, a server system such as the server system 150 explained with reference to FIGS. 2A-2B and 8. Operations of the flow diagram 1000, and combinations of operation in the flow diagram 1000, may be implemented by, for example, hardware, firmware, a processor, circuitry and/or a different device associated with the execution of software that includes one or more computer program instructions.

In one embodiment, the method 1000 in the flow diagram may be executed by a server system associated with a user bank (i.e. an issuer server) or a payment server associated with a payment network, such as the Mastercard® payment system interchange network. It is noted that the operations of the method 1000 can be described and/or practiced by using other server systems, such as the acquirer server 130 shown in FIG. 1. The method 1000 starts at operation 1002.

At 1004 of the method 1000, user payment account information is received. The user may provide the payment account information on a merchant portal to initiate a payment to a merchant for purchasing one or more items displayed on the merchant portal.

At 1006 of the method 1000, an authorization of the user payment account information is performed. For example, the user payment account information may include information related to a payment card associated with the user. The authorization of the payment card may involve verifying with the payment card information with the payment card information available at the server system. Further, in some embodiments, the authorization may also include a check to determine if the payment transaction is covered by the balance in the user's payment account.

At 1008 of the method 1000, it is determined whether the authorization is successful or not. If the authorization is not successful, then 1010 is performed. At 1010 of the method 1000, the payment transaction is determined to be failed. The method stops at 1012.

If the authorization is successful, then 1014 is performed. At 1014, a one-time password (OTP) is generated to initiate user authentication.

At 1016, an encrypted image is generated by encrypting linked device ID and the OTP in an image available at the server system. As explained with reference to FIG. 7, the user may have linked one or more device ID(s) with the user payment account. The linked device IDs may be stored along with the user payment account information. The OTP and at least one device ID may be encrypted in an image to generate the encrypted image.

At 1018, the encrypted image is sent to the user. In at least one example embodiment, the user may receive the encrypted image (instead of receiving the OTP) and the user may upload the encrypted image on the merchant portal to authenticate a personal identity.

At 1020, the encrypted image uploaded by the user is received along with the device ID of the device used by the user for uploading the image.

At 1022, the device ID(s) and the OTPs are compared or matched. More specifically, the device ID of the device is compared with the device ID included in the encrypted image. Similarly, the OTP in the encrypted image is compared with the OTP available at the server system.

At 1024, it is determined whether the match was successful or not. If the match is successful, then at 1026, the payment transaction is approved and the processing of the payment transaction to transfer funds from the user's payment account to the merchant's payment account is initiated and the method 1000 ends at 1012. If the match is not successful, then the payment transaction is deemed to have failed at 1010 and the method 1000 ends at 1012.

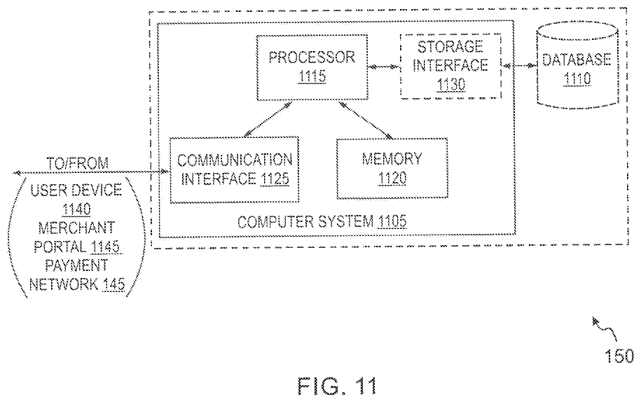

FIG. 11 is a simplified block diagram of a server system 150 configured to facilitate processing of payment transactions using encrypted images, in accordance with an example embodiment of the present disclosure. The server system 150 is an example of a server system that is a part of the payment network. Examples of the server system 150 includes, but not limited to, an issuer server, a payment server, an acquirer server, a server associated with a payment gateway, and the like. The server system 150 includes a computer system 1105 and a database 1110.

The computer system 1105 includes at least one processor 1115 for executing instructions. Instructions may be stored in, for example, but not limited to, a memory 1120. The processor 1115 may include one or more processing units (e.g., in a multi-core configuration). The processor 1115 is operatively coupled to a communication interface 1125 such that the computer system 1105 is capable of communicating with remote entities such a user device 1140 (e.g., electronic device associated with a user and hereinafter referred to as a device 1140), a merchant portal 1145 or any entity within the payment network 145 (shown in FIG. 1). For example, the communication interface 1125 may facilitate causing display of an application interface or a Web/online interface on the device 1140 for enabling the user to request generation of an encryption image. The communication interface 1125 may also facilitate reception of device ID and payment transaction information and facilitate the generation of the encrypted image. The communication interface 1125 also facilitates provisioning of the encrypted image to the device 1140. The communication interface 1125 may also facilitate communication with other entities of the payment network, such as with the payment server 140 for example. The communication interface 1125 may receive payment account information and/or encrypted image from the merchant portal 1145.

The processor 1115 may also be operatively coupled to the database 1110. The database 1110 is any computer-operated hardware suitable for storing and/or retrieving data, such as, but not limited to, user payment account information, linked device IDs of the users, images for configuring encrypted images, and the like. The database 1110 may include multiple storage units such as hard disks and/or solid-state disks in a redundant array of inexpensive disks (RAID) configuration. The database 1110 may include a storage area network (SAN) and/or a network attached storage (NAS) system. In some embodiments, the database 1110 is integrated within the computer system 1105. For example, the computer system 1105 may include one or more hard disk drives as the database 1110. In other embodiments, the database 1110 is external to the computer system 1105 and may be accessed by the computer system 1105 using a storage interface 1130. The storage interface 1130 is any component capable of providing the processor 1115 with access to the database 1110. The storage interface 1130 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1115 with access to the database 1110.

The computer system 1105 in conjunction with the database 1110 is configured to perform the various function as explained with reference to the server system 150 in FIGS. 2A-2B and 6A-6B. For example, the processor 1115 of the computer system 1105 is configured to provision an image encryption application or a Web service for generating encrypted images to a plurality of users. The processor 1115 is also configured to generate an encrypted image using the device ID of the user device, an image uploaded by the user, and the payment account information provided by the user. In some embodiments, the processor 1115 is also configured to generate an OTP in relation to the successful authentication of the user's payment account information received in relation to a payment transaction. Further, the processor 1115 is configured to generate an encrypted image by encrypting the user device ID and the OTP. The processor 1115 is also configured to decrypt the encrypted image for extracting the device ID and the payment transaction information (i.e. the payment account information or the OTP). The processor 1115 may then compare the device ID extracted from the image with the device ID of the user and subsequent to successful matching of the device IDs, facilitate processing of the payment transaction. If the server system 150 is embodied as an acquirer server or a server associated with a payment gateway, then the processing of the payment transaction may imply provisioning the payment transaction information to the issuer server 135 for initiating transfer of funds from the user's payment account to the merchant's payment account. If the server system 150 is embodied as the issuer server 135, then the processing of the payment transaction may imply authorizing the payment account information and causing transfer of funds from the user's payment account to the merchant's payment account.

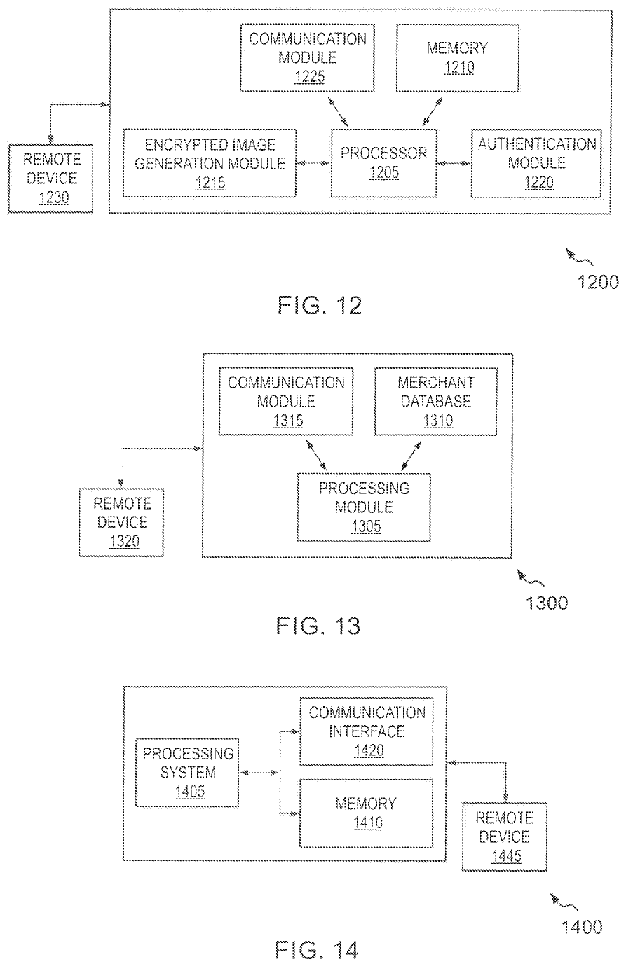

FIG. 12 is a simplified block diagram of an issuer server 1200 configured to facilitate processing of payment transactions with encrypted images, in accordance with an example embodiment of the present disclosure. The issuer server 1200 is an example of the issuer server 135 of FIG. 1 or may be embodied in the issuer server 135. The issuer server 1200 is associated with an issuer bank/issuer, in which a user may have a payment account, which provides an option to the user to link one or more device IDs with the user payment account. The issuer server 1200 includes a processor 1205 operatively coupled to a memory 1210, an encrypted image generation module 1215, an authentication module 1220 and a communication module 1225. The components of the issuer server 1200 provided herein may not be exhaustive, and that the issuer server 1200 may include more or fewer components than that of depicted in FIG. 12. Further, two or more components may be embodied in one single component, and/or one component may be configured using multiple sub-components to achieve the desired functionalities. Some components of the issuer server 1200 may be configured using hardware elements, software elements, firmware elements and/or a combination thereof.

The memory 1210 is configured to store machine executable instructions to be accessed by the processor 1205. Additionally, the memory 1210 stores information related to, contact information of the user, bank account number (i.e. user payment account number), BICs, payment card details, internet banking information, PIN, mobile personal identification number (MPIN) for mobile banking, and the like. This information is retrieved by the processor 1205 for cross-verification during payment transactions.

In some embodiments, the processor 1205 is configured to provision an application or a web service to a plurality of users for enabling the users to request generation of respective encrypted images.

In one embodiment, the encrypted image generation module 1215 is configured to generate an encrypted image using the device ID of the user device, an image uploaded by the user, and the payment account information provided by the user.

In some embodiments, the processor 1205 is also configured to generate an OTP in relation to the successful authentication of the user's payment account information received in relation to a payment transaction. In such a scenario, the encrypted image generation module 1215, is configured to generate an encrypted image by encrypting the user device ID and the OTP.

The processor 1205 is also configured to decrypt the encrypted image for extracting the device ID and the payment transaction information (i.e. the payment account information or the OTP). The processor 1205 may then compare the device ID extracted from the image with the device ID of the user and subsequent to successful matching of the device IDs, facilitate processing of the payment transaction, i.e. cause transfer of funds from the user's payment account to the merchant's payment account.

The processor 1205, in conjunction with the authentication module 1220, is configured to validate the user payment account information such as the payment card information, the PIN (e.g., whether the four-digit numeric code matches the PIN issued by the issuer), and the like. The authentication module 1220 is also configured to perform authentication of users using OTP or any such 3DS means. Upon successful authentication only, the processor 1205 is configured to process the payment from the user's payment account to the merchant.

The processor 1205 is further configured to communicate with one or more remote devices such as a remote device 1230 using the communication module 1225 over a network such as the network 160 or the payment network 145 of FIG. 1. The examples of the remote device 1230 include, a user device 1140, the merchant portal 1145, the payment server 140, the acquirer server 130, other computing systems of the payment network 145 and the like. The communication module 1225 is capable of facilitating such operative communication with the remote devices and cloud servers using API (Application Program Interface) calls.

FIG. 13 is a simplified block diagram of an acquirer server 1300 configured to facilitate processing of payment transactions with encrypted images, in accordance with an example embodiment of the present disclosure. The acquirer server 1300 is associated with the acquirer bank of a merchant where the merchant has established an account to accept payment from users. The acquirer server 1300 is an example of the acquirer server 130 of FIG. 1 or may be embodied in the acquirer server 130. In at least some embodiments, the acquirer server 1300 is an example of the server system 150 explained with reference to FIGS. 2A-2B and 8.

The acquirer server 1300 includes a processing module 1305 communicably coupled to a merchant database 1310 and a communication module 1315. The components of the acquirer server 1300 provided herein may not be exhaustive, and that the acquirer server 1300 may include more or fewer components than that of depicted in FIG. 13. Further, two or more components may be embodied in one single component, and/or one component may be configured using multiple sub-components to achieve the desired functionalities. Some components of the acquirer server 1300 may be configured using hardware elements, software elements, firmware elements and/or a combination thereof.

The merchant database 1310 includes data related to each merchant, such as, but not limited to, a merchant primary account number (PAN), a merchant name, a merchant category code (MCC), a merchant city, a merchant postal code, a merchant brand name, a merchant ID and the like. The processing module 1305 is configured to use the merchant ID to identify the merchant during the normal processing of payment transactions, adjustments, chargebacks, end-of-month fees and so forth. The merchant ID is different than other merchant account numbers, particularly those that identify merchants to the equipment (e.g., the POS terminals or any other merchant electronic devices) they use for processing transactions. A merchant with a single merchant processing account number may use several terminals at one location, resulting in one merchant ID and several terminal identification numbers (TIDs). The processing module 1305 may be configured to store and update such merchant information in the merchant database 1310 for later retrieval.

In an embodiment, the communication module 1315 is capable of facilitating operative communication with a remote device 1320 (e.g., the device 1140, the merchant portal 1145, and/or the payment server 140) using API calls. The communication may be achieved over a communication network, such as the network 160.

In some embodiments, the processing module 1305 in conjunction with the communication module 1315 may be configured to cause provisioning of an interface, such as an application interface and/or online/Web interface for generating encrypted images. Further, the processing module 1305 in conjunction with the communication module 1315 may be configured to cause provisioning of an interface displaying an option to the users to pay using encrypted images.

Further, the processing module 1305 may be configured to decrypt the encrypted images to extract the device ID and the match the extracted device ID with the device ID of the device 1140 used by the user for accessing the merchant interface. The processing module 1305 may be configured to facilitate processing of the payment transactions by forwarding the payment transaction information/encrypted images to the payment server 140/issuer server 1300 to effect transfer of funds from the user's payment account to the merchant's payment account.

In some embodiments, the processing module 1305 is configured to receive the debited transaction amount from the payment server 140 or the issuer server 135 (or the issuer server 1300) using the communication module 1315. Thereafter, the processing module 1305 may retrieve merchant PAN from the merchant database 1310 to credit the transaction amount in the acquirer account of the merchant. Further, the processing module 1305 may be configured to send the transaction status to a merchant device.

FIG. 14 is a simplified block diagram of a payment server 1400 configured to facilitate processing of payment transactions with encrypted images, in accordance with an example embodiment of the present disclosure. The payment server 1400 may correspond to payment server 140 of FIG. 1. As explained with reference to FIG. 1, the payment server 140 is associated with a payment network 145. The payment network 145 may be used by the issuer server 1200 and the acquirer server 1000 as a payment interchange network. Examples of payment interchange network include, but not limited to, Mastercard® payment system interchange network.

The payment server 1400 includes a processing system 1405 configured to extract programming instructions from a memory 1410 to provide various features of the present disclosure. The components of the payment server 1400 provided herein may not be exhaustive, and that the payment server 1400 may include more or fewer components than that of depicted in FIG. 14. Further, two or more components may be embodied in one single component, and/or one component may be configured using multiple sub-components to achieve the desired functionalities. Some components of the payment server 1400 may be configured using hardware elements, software elements, firmware elements and/or a combination thereof.

In one embodiment, the processing system 1405 in operable communication with an acquirer server associated with a merchant bank may be configured to cause provisioning of an interface, such as an application interface and/or online/Web interface via a communication interface 1420 for enabling the users to request generation of respective encrypted images.

In one embodiment, the processing system 1405 is configured to generate an encrypted image using the device ID of the user device, an image uploaded by the user, and the payment account information provided by the user. The processing system 1405 is also configured to decrypt the encrypted image for extracting the device ID and the payment transaction information (i.e. the payment account information or the OTP). The processing system 1405 may then compare the device ID extracted from the image with the device ID of the user and subsequent to successful matching of the device IDs, facilitate processing of the payment transaction, i.e. cause transfer of funds from the user's payment account to the merchant's payment account.

In some embodiments, the processing system 1405 may be configured to receive an intimation of the successful processing of the payment from a user to a merchant from the issuer server 1200 (explained with reference to FIG. 12) associated with the user bank (i.e. the issuer). The processing system 1405 may further be configured to intimate the acquirer server 1300 of the successful processing of the payment and also facilitate transfer of the transaction amount from the user payment account to the merchant payment account.

In some embodiments, the processing system 1405 may receive payment account information, such as for example a payment card information, in relation to a payment transaction. The processing system 1405 may be configured to identify the user and the user bank by comparing the payment card information with a stored copy in the memory 1410 and accordingly forward the payment card information to the appropriate issuer server 1200 for processing the payment from the user to the merchant.

In an embodiment, a remote device 1445 may correspond to the issuer server 1200, the acquirer server 1300 (shown in FIG. 13), the user device 1140 (shown in FIG. 11), the merchant portal 1145 (shown in FIG. 11) or any other entity on the payment network 145 (shown in FIG. 1).

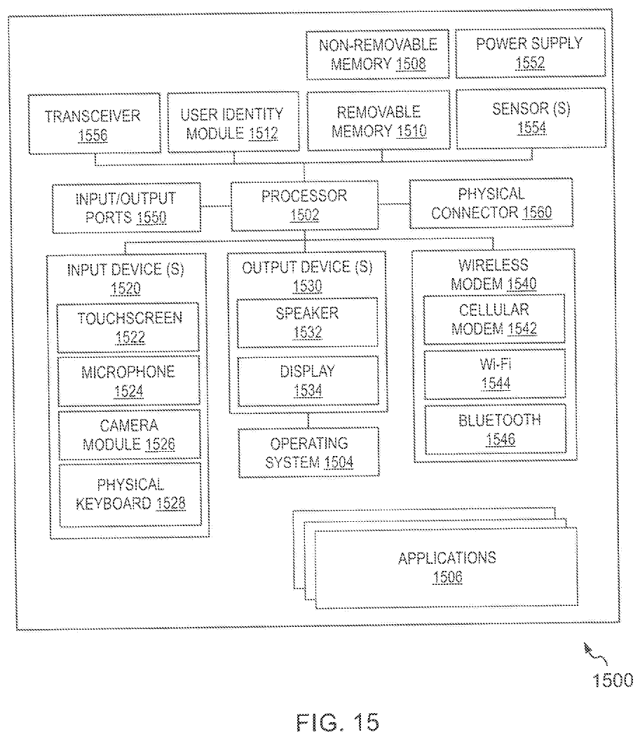

FIG. 15 shows simplified block diagram of an electronic device 1500 capable of implementing the various embodiments of the present disclosure. For example, the electronic device 1500 may correspond to a user device 1140 (shown in FIG. 11). The electronic device 1500 is depicted to include one or more applications 1506.

It should be understood that the electronic device 1500 as illustrated and hereinafter described is merely illustrative of one type of device and should not be taken to limit the scope of the embodiments. As such, it should be appreciated that at least some of the components described below in connection with that the electronic device 1500 may be optional and thus in an example embodiment may include more, less or different components than those described in connection with the example embodiment of the FIG. 15.

The illustrated electronic device 1500 includes a controller or a processor 1502 (e.g., a signal processor, microprocessor, ASIC, or other control and processing logic circuitry) for performing such tasks as signal coding, data processing, image processing, input/output processing, power control, and/or other functions. An operating system 1504 controls the allocation and usage of the components of the electronic device 1500 and support for one or more payment application programs (see, applications 1506), that implements one or more of the innovative features, such as providing an interface for requesting generation of the encrypted image, or for providing an input related to selection of the option to pay using the encrypted image. The payment application program may also enable generation of the encrypted image to facilitate user payments to a merchant, as described herein. In addition, the applications 1506 may include common mobile computing applications (e.g., telephony applications, email applications, calendars, contact managers, web browsers, messaging applications) or any other computing application.

The illustrated electronic device 1500 includes one or more memory components, for example, a non-removable memory 1508 and/or a removable memory 1510. The non-removable memory 1508 and/or the removable memory 1510 may be collectively known as database in an embodiment. The non-removable memory 1508 can include RAM, ROM, flash memory, a hard disk, or other well-known memory storage technologies. The removable memory 1510 can include flash memory, smart cards, or a Subscriber Identity Module (SIM). The one or more memory components can be used for storing data (such as encrypted images, device IDs, etc.) and/or code for running the operating system 1504 and the applications 1506. The electronic device 1500 may further include a user identity module (UIM) 1512. The UIM 1512 may be a memory device having a processor built in. The UIM 1512 may include, for example, a subscriber identity module (SIM), a universal integrated circuit card (UICC), a universal subscriber identity module (USIM), a removable user identity module (R-UIM), or any other smart card. The UIM 1512 typically stores information elements related to a mobile subscriber. The UIM 1512 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1500 can support one or more input devices 1520 and one or more output devices 1530. Examples of the input devices 1520 may include, but are not limited to, a touch screen/a display screen 1522 (e.g., capable of capturing finger tap inputs, finger gesture inputs, multi-finger tap inputs, multi-finger gesture inputs, or keystroke inputs from a virtual keyboard or keypad), a microphone 1524 (e.g., capable of capturing voice input), a camera module 1526 (e.g., capable of capturing still picture images and/or video images) and a physical keyboard 1528. Examples of the output devices 1530 may include but are not limited to a speaker 1532 and a display 1534. Other possible output devices can include piezoelectric or other haptic output devices. Some devices can serve more than one input/output function. For example, the touch screen 1522 and the display 1534 can be combined into a single input/output device.

A wireless modem 1540 can be coupled to one or more antennas (not shown in the FIG. 15) and can support two-way communications between the processor 1502 and external devices, as is well understood in the art. The wireless modem 1540 is shown generically and can include, for example, a cellular modem 1542 for communicating at long range with the mobile communication network, a Wi-Fi compatible modem 1544 for communicating at short range with an external Bluetooth-equipped device or a local wireless data network or router, and/or a Bluetooth-compatible modem 1546. The wireless modem 1540 is typically configured for communication with one or more cellular networks, such as a GSM network for data and voice communications within a single cellular network, between cellular networks, or between the electronic device 1500 and a public switched telephone network (PSTN).

The electronic device 1500 can further include one or more input/output ports 1540, a power supply 1542, one or more sensors 1544 for example, an accelerometer, a gyroscope, a compass, or an infrared proximity sensor for detecting the orientation or motion of the user device 1500 and biometric sensors for scanning biometric identity of an authorized user, a transceiver 1546 (for wirelessly transmitting analog or digital signals) and/or a physical connector 1560, which can be a USB port, IEEE 1294 (FireWire) port, and/or RS-232 port. The illustrated components are not required or all-inclusive, as any of the components shown can be deleted and other components can be added.

The disclosed embodiments with reference to FIGS. 1 to 15, or one or more operations of the flow diagrams may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 150 its various components such as the computer system 1105 and the database 1110 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A payment processing method, the method comprising:
receiving, by a server system associated with a payment network, an encrypted image from a device of a user, the encrypted image comprising:
a device identifier (ID) associated with the device, and
at least one payment transaction information associated with a payment account of the user;
extracting, by the server system, the device ID and the at least one payment transaction information from the encrypted image;
matching, by the server system, the device ID with an available device ID at the server system; and
subsequent to successful matching of the device ID with the available device ID, processing by the server system, a payment transaction using the payment account based on the at least one payment transaction information.

2. The method as claimed in claim 1, wherein extracting the device ID and the at least one payment transaction information from the encrypted image comprises:
extracting the device ID in a first layer of decryption of the encrypted image; and
if there is a successful match of the extracted device ID with the available device ID, extracting the at least one payment transaction information in a second layer of decryption of the encrypted image.

3. The method as claimed in claim 1, wherein the at least one payment transaction information corresponds to one of a bank account related information and a payment card information associated with the payment account of the user.

4. The method as claimed in claim 3, further comprising:
receiving, by the server system, an encrypted image generation request from the device, the encrypted image generation request comprising an image available in the device of the user and the at least one payment transaction information;
capturing the device ID of the device of the user; and
encrypting the device ID and the at least one payment transaction information in the image to generate the encrypted image.

5. The method as claimed in claim 4, wherein the device ID and the at least one payment transaction information are encrypted using at least one steganographic encryption process.

6. The method as claimed in claim 5, wherein the at least one steganographic encryption process is configured to use binary representation of colors of pixels associated with the image to conceal the device ID and the at least one payment transaction information for generating the encrypted image.

7. The method as claimed in claim 1, wherein the at least one payment transaction information comprises a one-time password (OTP) for processing the payment transaction using the payment account.

8. The method as claimed in claim 7, wherein the server system is an issuer server associated with the payment account, and wherein the method further comprises:
receiving, by the issuer server, the device ID and a payment card information associated with the payment account;
matching, by the issuer server, the payment card information with available payment card information;
upon successful match, generating the OTP by the issuer server;
encrypting the OTP and the device ID in an image by the issuer server to generate the encrypted image; and
causing, by the issuer server, a provisioning of the encrypted image to the device of the user.

9. The method as claimed in claim 7, wherein the device ID and the OTP are encrypted in the image using at least one steganographic encryption process.

10. The method as claimed in claim 7, wherein the encrypted image is uploaded on a merchant portal by the user using the device to authenticate a user identity.

11. The method as claimed in claim 10, wherein processing of the payment transaction comprises matching the OTP extracted from the encrypted image with the OTP generated by the issuer server.

12. A server system in a payment network for processing payments, the server system comprising:
a memory comprising stored instructions; and
at least one processor communicably coupled to the memory, the processor configured to execute the stored instructions to cause the server system to perform at least
receive an encrypted image from a device of a user, the encrypted image comprising a payment card information associated with a payment card of the user,
extract a device ID of the device of the user from a communication associated with the encrypted image between the device and the server system,
match the device ID with an available device ID with the server system; and
subsequent to successful matching of the device ID with the available device ID, extract the payment card information from the encrypted image, and
process a payment transaction using the payment card based on the payment card information extracted from the encrypted image.

13. The server system as claimed in claim 12, wherein the server system is further caused to:
receive an encrypted image generation request from the device, the encrypted image generation request comprising an image available in the device of the user and the payment card information;
capture the device ID of the device of the user from the encrypted image generation request;
encrypt the payment card information in the image to generate the encrypted image; and
store the captured device ID as the available device ID for the device of the user.

14. The server system as claimed in claim 13, wherein the payment card information is encrypted using at least one steganographic encryption process.

15. The server system as claimed in claim 12, wherein the encrypted image is uploaded on a merchant portal by the user using the device to initiate a payment to a merchant.

16. An issuer server in a payment network for processing payments, the issuer server comprising:
a memory comprising stored instructions; and
at least one processor communicably coupled to the memory, the processor configured to execute the stored instructions to cause the issuer server to perform at least
receive an encrypted image from a device of a user, the encrypted image comprising
a device identifier (ID) associated with the device, and
a one-time password (OTP) for processing a payment transaction using a payment card of the user,
extract the device ID and the OTP from the encrypted image,
match the device ID with an available device ID, and
subsequent to successful matching of the device ID with the available device ID, process the payment transaction using the payment card.

17. The issuer server as claimed in claim 16, wherein extracting the device ID and the OTP from the encrypted image comprises:
extracting the device ID in a first layer of decryption of the encrypted image; and
if there is a successful match of the extracted device ID with the available device ID, extracting the OTP in a second layer of decryption of the encrypted image.

18. The issuer server as claimed in claim 16, wherein the issuer server is further caused to:
receive the device ID and a payment card information associated with the payment card;
match the payment card information with available payment card information;
upon successful match, generate the OTP;
encrypt the OTP and the device ID in an image to generate the encrypted image; and
cause a provisioning of the encrypted image to the device of the user.

19. The issuer server as claimed in claim 16, wherein the device ID and the OTP are encrypted in the image using at least one steganographic encryption process.

20. The issuer server as claimed in claim 19, wherein processing of the payment transaction comprises matching the OTP extracted from the encrypted image with the OTP generated by the issuer server.
